(19) United States
(12) Patent Application Publication
(10) Pub. No.: US 2019/0217238 A1
(43) Pub. Date: Jul. 18, 2019

(54) Filter Element

(71) Applicant: MANN+HUMMEL GmbH, Ludwigsburg (DE)

(72) Inventor: Klaus Gehwolf, Mamming (DE)

(21) Appl. No.: 16/368,386

(22) Filed: Mar. 28, 2019

Related U.S. Application Data
(63) Continuation of application No. PCT/EP2017/070898, filed on Aug. 18, 2017.

(30) Foreign Application Priority Data
Sep. 30, 2016 (DE) 102016011754.0

(51) Int. Cl. B01D 46/52; B01D 46/24; F02M 35/024

(52) U.S. Cl. CPC B01D 46/522; B01D 46/2403; B01D 2275/208; F02M 35/02483; F02M 35/0245

(57) ABSTRACT

A filter element has a folded bellows folded in a zigzag shape and provided with folds. The folded bellows has a first section with a first curvature and a second section with a second curvature. The first curvature is greater than the second curvature. The folds of the folded bellows in the first section have a varying fold height.

### CROSS-REFERENCE TO RELATED APPLICATIONS

This application is a continuation application of international application No. PCT/EP2017/070898 having an international filing date of 18 Aug. 2017 and designating the United States, the international application claiming a priority date of 30 Sep. 2016 based on prior filed German patent application No. 10 2016 011 754.0, the entire contents of the aforesaid international application and the aforesaid German patent application being incorporated herein by reference.

### BACKGROUND OF THE INVENTION

The present invention concerns a filter element for filtering air in a motor vehicle and/or operating media of a motor vehicle, in particular, an air filter for combustion air of an internal combustion engine.

Even though applicable to any filter elements, the present invention as well as the set of problems it concerns will be described in the following for an air filter of a motor vehicle.

In the past, air filter elements have been manufactured mostly in a cylinder shape and provided with a filter medium folded in zigzag shape as an endless folded bellows. A high-speed air filter is disclosed, for example, in DE 4414960 A1 in which a cylindrical filter element is formed of a filter material that has different fold heights. Viewed from an outer circumferential surface, alternating folds reach farther into the interior than intermediately positioned shorter folds.

A similar folding geometry is realized in a filter cylinder according to DE 10250969 A1 in which a filter cylinder for hydraulic oil is formed of filter material folded in zigzag shape wherein, viewed from the exterior, deep and shallow folds are resting against each other.

The restriction to cylinder-shaped and circular-shaped folded bellows is partially perceived as disadvantageous because the installation space that is present, for example, in the engine compartment or in the vehicle cannot always be utilized efficiently.

### SUMMARY OF THE INVENTION

In view of the above, the present invention has the object to create an improved filter element with a bellows geometry adaptable to the installation space, which filter element enables a good installation space utilization, in particular, adapted to the existing requirements of an installation space with different geometries, while providing a good fold distribution and good utilization of the filter surface.

Accordingly, a filter element for filtering air in a motor vehicle or for filtering operating media of a motor vehicle is proposed. The filter element comprises a fold-comprising folded bellows folded in zigzag shape which, in a first section, comprises a first curvature and, in a second section, comprises a second curvature. The first curvature in this context is greater than the second curvature and the folds of the first section have a varying fold height. Preferably, the folds of the second section have a constant fold height.

Due to the configuration of the folded bellows that comprises sections with different curvatures, the predetermined requirements in regard to the installation volume can be fulfilled beneficially. The varying fold height enables at the same time a good utilization of the filter surface. Due to the varying fold height, the filter material that forms the folded bellows and is in particular a flat web can provide, on the one hand, a beneficially large filter surface matched to the respective curvature and, on the other hand, clogging of folds contacting each other can be prevented.

As a whole, an improved filter surface and a more beneficial fold distribution are obtained compared to conventional filter elements that have folded bellows with differently curved sections.

In embodiments, the first section has first folds with a first fold height and second folds with a second fold height. In this context, the first fold height is higher or larger than the second fold height. For example, alternating fold heights enable an adaptation of the curvature to the desired installation conditions. For example, in more strongly curved sections, the different fold heights can be adjusted alternatingly, for example, in such a way that a defined curvature for the respective section results.

Conceivable is that the first folds and the second folds form an M-fold. In case of an M-fold, between two high or deep folds an intermediately positioned fold is provided that has a reduced fold depth or height.

In embodiments of the filter element, the first section comprises first folds with a first fold height between an inner radius and an outer radius. Second folds with a second fold height reach from the outer radius in the direction toward the inner radius. The second folds are arranged between the first folds. For example, in sections one can assume inner and outer radii between which the zigzag-shaped folds of the folded bellows extend. Moreover, folds are provided that extend between the outer radius and an intermediate radius that is greater than the inner radius. In this way, a uniform fold distribution can be achieved and the filter surface can be advantageously expanded with respect to the radius even for an installation space with different geometry requirements; thus, the installation space can be efficiently utilized and a good fold distribution as well as an optimal utilization of the filter surface is achieved.

For example, the first section is a first circular section and the second section is a straight section. In this way, any shapes of the folded bellows can be obtained, for example, depending on the size of the circular arc segments. Conceivable is a stadium shape or an oval shape, for example.

In embodiments, the folded bellows has a third folded section with a third curvature. In this context, the third curvature is greater than the second curvature and the folds of the third section have a varying fold height. For example, the curvatures may perform a sign change along a circumference of the filter element. This means that, viewed from an inner region of the folded bellows, there are protrusions as well as constrictions. For example, the several sections can form a barbell-shaped cross section, i.e., in the projection onto the fold profiles, along the folds. In embodiments, the third section is also a second circular section.

Preferably, the folded bellows is formed of a single media web, for example, a flat filter material, wherein a connection to an endless folded bellows is realized in a region of constant fold height. In this way, a stable fluid-tight connection between fold sections can be achieved.

In a section of greater curvature, embossments in the filter material that cause a defined spacing, in particular, in the outer region of the folds, can be provided for spacing apart folds that are resting against each other.

In embodiments, in the sections of varying fold height every other fold is shorter by 20% to 60% than the neighboring folds. In embodiments, the fold height between neighboring folds varies by 40% to 60%. Conceivable are, for example, fold heights between 15 mm and 40 mm. Preferably, a fold height of the sections with constant folds of 20 mm to 30 mm is achieved.

In embodiments, the folded bellows has a radial extension that changes in axial direction. For example, a conical filter element can be provided in which the respective base surface is an oval or a stadium-shaped cross section. In this way, installation dimensions can be obtained that are particularly good and matched to the respective use.

In embodiments, the folded bellows is provided with an upper or lower end disk which is attached to the fold profiles in a fluid-tight manner, respectively. In this way, a stabilization of the cylinder or cone shape with base surfaces is achieved that have a contour with different curvatures. The respective end disk forms, for example, an area like a stadium-shaped or oval cross section. As end disk material, a foamed PUR material is conceivable in particular.

The filter element is suitable in particular for filtering air in a motor vehicle. Moreover, the filter element can be an air filter, a cabin air filter or the like. Moreover, the filter element can be embodied to filter operating media liquids such as water, oil, urea solution or fuel, in particular diesel fuel, kerosene or gasoline. The filter element can find use in motor vehicles, trucks, construction machinery, watercraft, rail vehicles, in building technology or in aircraft.

The filter element can be folded from a single areal filter material sheet. As folds, for example, M-folds, zigzag folds or W folds are known. The filter medium can be embossed during production of the filter element and subsequently folded sharp-edged at the embossment edges with formation of the fold edges. The connection of a folded material filter sheet to the folded bellows is realized preferably in the section with the reduced curvature. Moreover, the connection of a folded material sheet to the folded bellows can be realized in the region of a constant folding and/or in the region of a varying folding.

As starting material, an areal material filter sheet can be provided which is correspondingly reshaped. The folded bellows is, for example, a filter fabric, a laid filter material or a filter nonwoven. In particular, the folded bellows can be produced by a spunbond method or meltblown method. Furthermore, the folded bellows can be felted or needled. The folded bellows can comprise natural fibers such as cotton or synthetic fibers, for example, of polyester, polyphenylene sulfide, or polytetrafluoroethylene. The fibers can be oriented during processing in the machine direction, slanted thereto and/or transverse thereto.

The folded bellows can be single-layered or multi-layered. The medium can moreover comprise an adsorption medium such as active carbon. Moreover, the folded bellows can comprise an antimicrobial and/or anti-allergenic action. As antimicrobial substance, for example, zinc pyrithione or nanosilver is conceivable, and as an anti-allergenic substance, for example, polyphenol is conceivable.

The filter element comprises in particular a raw side and a clean side, wherein, in operation of the filter element, the fluid to be purified flows through the folded bellows from the raw side to the clean side.

Further possible implementations of the filter element comprise also combinations, not explicitly mentioned, of features or configurations described above or in the following in respect to the embodiments. Moreover, a person of skill in the art will add also individual aspects as improvements or supplements to the respective basic configuration of the filter element and/or of the filter arrangement.

Further configurations of the filter element are subject matter of the dependent claims as well as of the embodiments of the filter element described in the following. Moreover, the filter element will be explained in more detail with the aid of embodiments with reference to the accompanying Figures.

### BRIEF DESCRIPTION OF THE DRAWINGS

FIG. 1 shows a schematic illustration of a filter element according to a first embodiment.

FIG. 2 shows a schematic detail view of a first section of the folded bellows of FIG. 1.

FIG. 3 is a schematic illustration of a filter arrangement with a filter element.

FIG. 4 shows a schematic illustration of a filter element as a variant of FIG. 1.

In the Figures, same reference characters refer to same functions or same elements inasmuch as nothing to the contrary is indicated.

### DESCRIPTION OF PREFERRED EMBODIMENTS

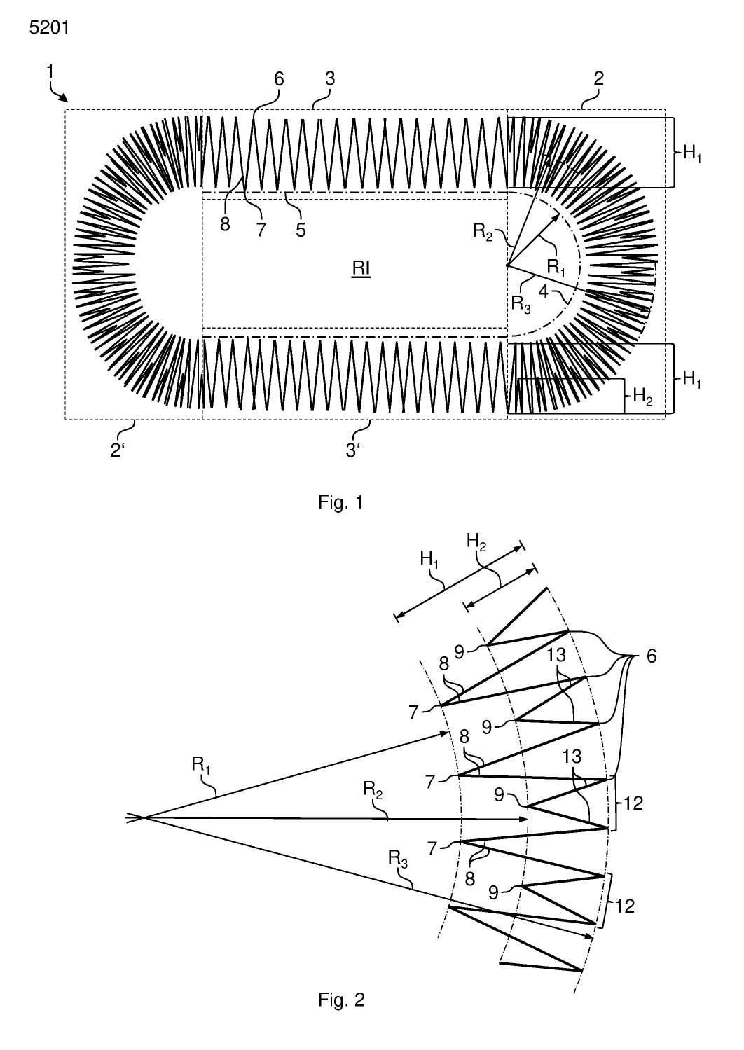

FIG. 1 shows a schematic illustration of a filter element in plan view. The filter element has an endless folded bellows 1 which is formed of a zigzag-shaped filter medium. In the cross section view of FIG. 1, one can recognize a stadium shape of the folded bellows 1 with two curved round sections 2, 2′ and two straight sections 3, 3′. In particular at the straight sections 3, 3′, one can see the zigzag-shaped folds with outer fold edges 6 and inner fold edges 7 between which fold sections 8 are positioned. In this and in the following Figures, only some fold edges and fold sections are provided with reference characters in an exemplary fashion.

The straight fold sections 3, 3′ have no curvature but extend straight. This is indicated by the dash-dotted line 5. In order to realize the oval shape or stadium shape, further curved sections 2, 2′ with folds are provided. The resulting curvature is indicated by the dash-dotted line 4 and follows in the illustrated example a circular section. The sections 2, 2′ with a circular curvature 4 have thus a stronger curvature than the straight sections 3, 3′ that have no curvature 5. In FIG. 1, a radius R₁ for the right circular section 2 is indicated in order to illustrate the curvature 4.

In the straight sections 3, 3′, the spacings of the inner fold edges 7 and of the outer fold edges 6 are constant. One speaks in this context also of a constant fold height H₁ or constant fold depth. In the more strongly curved circular sections 2 or 2′, folds with different fold height are provided. The example of the section 2 illustrates that folds of the height H₁, identical to the fold height of the straight sections 3, 3′, are present. Moreover, less deep folds are provided which have a height H₂<H₁. One can say that, between folds of the depth H₁, folds with reduced fold depth H₂ are provided from the exterior. The folds of reduced depth, i.e., with less wide fold sections, can also be referred to as intermediate folds.

In this way, it is made easier to maintain the curvature 4 in the stronger curved section 2 and still ensure a sufficient or large filter surface. In FIG. 2, a detail illustration of a section 2 is illustrated in order to explain the fold geometry.

In FIG. 2, three circular arc sections with a respective radius R₁, R₂, and R₃ are indicated. The radius R₁ corresponds to the inner radius R₁ as indicated in FIG. 1 for the section 2. The radius R₃ corresponds to the outer radius of the section 2. Fold sections 8 extend between the inner and the outer radius R₁, R₃. These folds have a fold height H₁=R₃−R₁. The resulting outer fold edges are identified by 6 and the inner fold edges by 7. Moreover, at regular spacings folds with reduced fold height H₂ are provided. Between two fold sections 8 with great fold depth H₁ a fold 12 with shorter fold sections 13 is provided that adjoin a fold edge 9. The fold edge 9 extends on the circular section according to radius R₂ which can also be referred to as intermediate radius.

One can speak of contacting M-shaped folds or M-folds. This is indicated by reference character 12. The folds with reduced height H₂ extend from the exterior in the direction toward the interior RI of the resulting endless folded bellows (compare FIG. 1). In the orientation of FIG. 2, the interior of the folded bellows is to the left and the exterior space to the right.

Due to the M-folds or due to the varying fold height as a function of the curvature radius of the section in the folded bellows, it is prevented, on the one hand, that the fold sections snugly contact each other, in particular in the region of the inner radius R₁, and additionally the fold stability is increased. On the one hand, the folds with reduced height H₂ space apart the fold sections 8 with great depth and provide an additional contribution to the filter surface. As a whole, an improved fold distribution relative to sections with constant fold height is provided in this way.

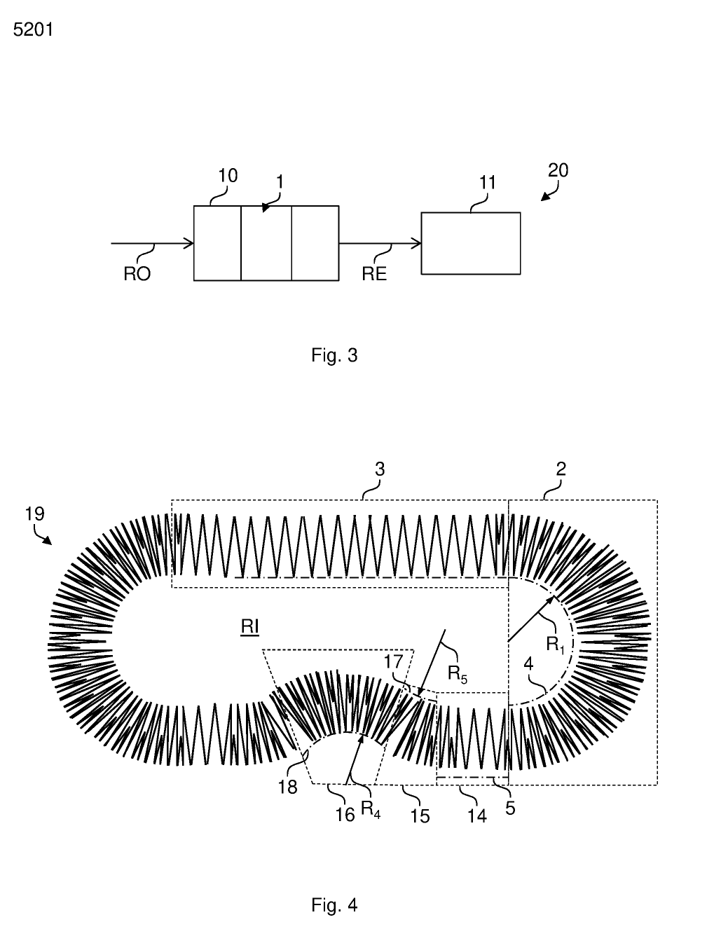

The folded bellows is suitable in particular for use as an air filter for intake air of a motor in a motor vehicle. In FIG. 3, in an exemplary fashion an embodiment for a filter arrangement 20 is indicated. The filter arrangement 20 comprises a filter housing 10 in which a filter element 1 of the type of an endless folded bellows, as illustrated, for example, in FIG. 1, is inserted. Raw air RO is supplied to the filter housing 10, guided through the filter medium with its folds, and supplied as clean air RE to an internal combustion engine 11 of a motor vehicle. In this way, it is achieved that the combustion air RO is purified from contaminants or particles.

In FIG. 4, a variant of FIG. 1 or further development of a filter element as an air filter is illustrated. The filter element comprises again an endless folded bellows 19 that comprises several sections of different curvature illustrated in cross section. A first section 2 is illustrated with M-folds and varying fold heights, as explained in connection with section 2 of FIG. 1. In clockwise direction, a straight section 14, a curved section 15, and a further curved section 16 adjoin the section 2. In order to close the circumference to the straight section 3, further curved sections, not identified in detail, of filter material folded in a zigzag shape are provided.

Along the circumference of the folded bellows 19, the curvature changes its sign. The section 2 is identified with an inner radius of curvature R₁ and the dash-dotted curvature 4. The adjoining straight section 14 has a disappearing curvature 5, the following section 15 a curvature 17, and the section 16 has a curvature 18 which can be referred to by a circle with the circle radius R₄. One can see that the curvature, viewed from the interior RI of the folded bellows, changes its sign. At the transition from the section 15 to the section 16, the center of the circle for the radii R₅ and R₄ are displaced from the inner side RI to the exterior side. It is possible, for example, that the installation situation requires that folded bellows with changing curvature and, in particular, a sign change from concave to convex be made available. In this context, it is beneficial to realize the folds with varying height. In the example of FIG. 4, M-shaped folds result also wherein, for increasing the filter surface, folds with reduced depth or height in the direction relative to the respective radius of curvature are provided.

Even though the invention has been explained with the aid of embodiments, it can be modified in many ways. For example, in addition to the illustrated radii and shapes for the curved sections, other oval shapes of endless folded bellows can be provided also. It is possible to provide in the interior of the folded bellows a support tube in order to stabilize the filter medium when fluid to be filtered passes through. In addition to the proposed M-folds, also irregular spacings of the intermediate folds and the provision of folds of reduced depth between folds of great depth are conceivable. It is possible also to apply end disks to the fold profiles in order to realize a closed filter element. The end disks can be provided with connecting sockets or other passages for inflow and outflow of raw or clean fluid.

### EMPLOYED REFERENCE CHARACTERS

1, 19 folded bellows
2, 3 section
4, 5 curvature
6 outer fold edge
7 inner fold edge
8 fold section
9 fold edge
10 air filter housing
11 motor
12 M-fold
13 short fold section
14, 15, 16 section
17, 18 curvature
20 filter arrangement
RO raw air
RE clean air
RI interior
Rᵢ, R₂, R₃ radius
H₁, H₂, H₃ fold height

What is claimed is:

1. A filter element comprising:
a folded bellows folded in a zigzag shape and comprising folds, wherein the folded bellows comprises a first section comprising a first curvature and further comprises a second section comprising a second curvature, wherein the first curvature is greater than the second curvature, and wherein the folds of the folded bellows in the first section have a varying fold height.

2. The filter element according to claim 1, wherein the folds of the folded bellows in the first section include first folds comprising a first fold height and further include second folds comprising a second fold height, wherein the first fold height is greater than the second fold height.

3. The filter element according to claim 2, wherein the first folds and the second folds form M-folds.

4. The filter element according to claim 1, wherein the folds of the folded bellows in the first section include first folds comprising a first fold height extending between an inner radius of the first section and an outer radius of the first section, and wherein the folds of the folded bellows in the first section further include second folds comprising a second fold height extending from the outer radius of the first section in a direction toward the inner radius, wherein the second folds are arranged between the first folds.

5. The filter element according to claim 1, wherein the first section is a circular section.

6. The filter element according to claim 1, wherein the second section is a straight section.

7. The filter element according to claim 1, wherein the folded bellows comprises a third section with a third curvature, wherein the third curvature is greater than the second curvature, and wherein the folds of the folded bellows in the third section comprise a varying fold height.

8. The filter element according to claim 7, wherein the third section is a circular section.

9. The filter element according to claim 1, wherein the folded bellows comprises a radial extension that changes in an axial direction of the folded bellows.

10. The filter element according to claim 1, wherein the folded bellows comprises an oval cross section or a stadium-shaped cross section.
